(19) United States
(12) Patent Application Publication
(10) Pub. No.: US 2012/0047218 A1
(43) Pub. Date: Feb. 23, 2012

(54) METHOD AND APPARATUS FOR OUTPUTTING MAIL SYSTEM AND E-MAILBOX SYSTEM

(75) Inventors: Xiaolong Zhang, Shenzhen City (CN); Hao Zhou, Shenzhen City (CN); Ziqun Huang, Shenzhen City (CN); Kai Xie, Shenzhen City (CN); Ming Zeng, Shenzhen City (CN); Tieming Huang, Shenzhen City (CN); Linjia Wan, Shenzhen City (CN)

(73) Assignee: TENCENT TECHNOLOGY (SHENZHEN) COMPANY LIMITED, Shenzhen City (CN)

(21) Appl. No.: 13/318,428

(22) PCT Filed: Apr. 14, 2010
(86) PCT No.: PCT/CN10/71767

§ 371 Date: Nov. 1, 2011

(30) Foreign Application Priority Data
May 7, 2009 (CN) 200910106957.3

(51) Int. Cl. G06F 15/16

(52) U.S. Cl. 709/206

(57) ABSTRACT

The present invention relates to network communication technologies, and discloses a method and apparatus for outputting a system mail and an E-mailbox system. The method includes: configuring, a special identification field for a system mail; scanning mails received by all Mail Transfer Agents of an E-mailbox system, and filtering special identification fields contained in the mails; determining whether the mails are system mails through checking whether the mails received by the E-mailbox system contain the special identification fields; when determining that a mail is a system mail, outputting the system mail in a mode different from a mode of outputting a normal mail. The method can prevents the system mail being faked, and facilitate users to differentiate system mails from normal mails.

### FIELD OF THE INVENTION

The present invention relates to network communication technologies, and more particularly to a method and apparatus for outputting a system mail and an E-mailbox system.

### BACKGROUND OF THE INVENTION

At With the development of network communication technologies, E-mailbox system has become a common tool for communicating between persons. System mails in the E-mailbox system refer to mails sent by a server of the E-mailbox system to users in the E-mailbox system. In the prior art, the system mails are identified using a mail identification technology, so as to be separated from normal mails.

The mail identification technology adopted by a conventional E-mailbox system includes adding an identification field into indexes of mails, and configuring the identification field to differentiate contents of the mails, e.g., whether the mails are important, by which users may differentiate system mails from normal mails. In some E-mailbox systems, a special LOGO picture is used in the contents of the mails to identify system mails.

Since the conventional E-mailbox system adopts a revisable identification mode to output system mails, generators of junk mails and cheat mails can output faked system mails by imitating the identification mode of system mails, i.e., in the conventional E-mailbox system, system mails are easy to be faked, so that users are difficult to differentiate true and false system mails, and thus the authority of the system mails can not be affirmed.

### SUMMARY OF THE INVENTION

Examples of the present invention provide a method, apparatus and system for outputting a system mail, to solve a problem that system mails in the conventional E-mailbox system are easy to be faked.

A method for outputting a system mail includes:

configuring, a special identification field for a system mail;

scanning mails received by all Mail Transfer Agents of an E-mailbox system, and filtering special identification fields contained in the mails;

determining whether the mails are system mails through checking whether the mails received by the E-mailbox system contain the special identification fields; when determining that a mail is a system mail, outputting the system mail in a mode different from a mode of outputting a normal mail.

An apparatus for outputting a system mail includes:

a special identification field configuring unit, configured to configure a special identification field for a system mail;

a special identification field filtering unit, configured to scan mails received by all Mail Transfer Agents of an E-mailbox system, and filter special identification fields contained in the mails;

a system mail outputting unit, configured to determine whether a mail is a system mail through checking whether the mails received by the E-mailbox system contain the special identification fields; when determining that the mail is a system mail, output the system mail in a mode different from a mode of outputting a normal mail.

A system for outputting a system mail includes the above apparatus.

In the examples of the present invention, a special identification field is configured for the system mail, the mails received by all Mail Transfer Agents of the E-mailbox system are scanned, and the special identification fields contained in the mails received by the Mail Transfer Agents are filtered; it is determined whether the mails are system mails by determining whether the mails contain the special identification fields, where only system mails sent by a server contain the special identification fields; when determining a mail is a system mail, the system mail is outputted in a mode different from a mode of outputting a normal mail. And thus, it can be determined that the system mail must be sent by the server, so as to prevent the system mail being faked, and make users differentiate system mails from normal mails.

### BRIEF DESCRIPTION OF THE DRAWINGS

FIG. 1 is a flowchart illustrating a method for outputting a system mail according to an example of the present invention.

FIG. 2 is a schematic diagram illustrating the structure of an apparatus for outputting a system mail according to an example of the present invention.

### DETAILED DESCRIPTION OF THE INVENTION

The present invention will be described in detail hereinafter with reference to accompanying drawings and examples to make the object, technical solution and merits of the present invention clearer. It should be understood that the examples described herein are only used to illustrate the present invention, but not used to limit the present invention.

In the examples of the present invention, a special identity field is configured for a system mail. Mails received by all Mail Transfer Agents of an E-mailbox system are scanned, and special identity fields contained in the mails received by the Mail Transfer Agents are filtered. It is determined whether the mails are system mails by determining whether the mails contain the special identity fields. When it is determined that a mail is a system mail, the system mail is outputted in a mode different from a mode of outputting a normal mail, so as to prevent the system mail from being faked.

A conventional E-mailbox system usually includes a mail server. There may be two sending procedures of a normal mail.

1) The mail is sent in the same domain, i.e., a sender and a receiver are in the serving area of the same mail server, e.g., test @ qq.com sends a mail to test1@qq.com, and the specific procedure is as follows.

After logging on a mail server of qq.com through a browser or a mail client software, a user test@qq.com sends a mail to a target user test1 @qq.com through a browser Mail User Agent (a web Mail User Agent) or a Simple Mail Transfer Protocol (SMTP) Agent; after receiving the mail, the mail server of qq.com caches the mail, then learns, according to the mail address test1@gq.com of the target user, that the mail is to be sent to the user test1@gq.com in the serving area of the mail server, and stores the cached mail in the folder of the user test1@qq.com.

2) A mail is sent between different domains, i.e., a sender and a receiver are not in the serving area of the same mail server, e.g., test@qq.com sends a mail to test@gmail.com, and the specific procedure is as follows.

After logging on a mail server of qq.com through a browser or a mail client software, a user test@qq.com sends a mail to a target user test@gmail.com through a web Mail User Agent or an SMTP Agent; after receiving the mail, the mail server of qq.com caches the mail, and then checks, according to the mailbox address test@gmail.com of the target user, whether there is a Mail Exchanger (MX) of gmail.com; after determining that there is an MX of gmail.com, the mail server of qq.com sends the mail through the MX Agent to a mail server of gmail.com designated by the MX; after receiving the mail, the mail server of gmail.com caches the mail, then learns, according to the mail address test@gmail.com of the target user, that the mail is to be sent to the user test@ gmail.com in the serving area of gmail.com, and stores the cached mail in the folder of the user test@gmail.com.

System mails are mails sent by the E-mailbox system to users served by the E-mailbox system. In the sending procedure, the system mails are not sent through the web Mail User Agent, the SMTP Agent and the MX Agent of normal mails, but are directly stored in the folder of the users through a background serving program of the E-mailbox system.

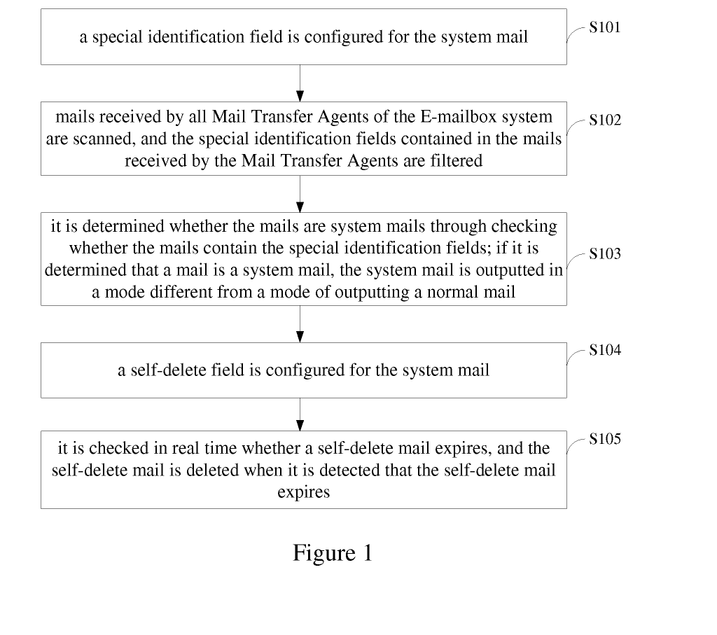

FIG. 1 is a flowchart illustrating a method for outputting a system mail according to an example of the present invention, which is described hereinafter in detail.

In step S101, a special identification field is configured for the system mail.

The special identification field is configured specially for the system mail, and is used for identifying a mail as a system mail. In the example of the present invention, the special identification field may be added into the header information of the mail, and also may be added into other parts of the mail, e.g., a mail body.

Since there may be multiple types of system mails, in order to identify the types of system mails, in another example of the present invention, multiple different values are configured for the special identity fields of the system mails, and each value indicates one type of system mail. When the system mails are sent, different values are configured for the special identity fields of the system mails, so as to identify the types of the system mails.

In step S102, mails received by all Mail Transfer Agents of the E-mailbox system are scanned, and the special identification fields contained in the mails received by the Mail Transfer Agents are filtered.

The Mail Transfer Agents of the E-mailbox system include Web Mail User Agents, SMTP (Simple Mail Transfer Protocol) Agents, MX (Mail exchanger) Agents and so on. The mails are scanned at the Mail Transfer Agents of the E-mailbox system, and it is determined whether the mails contain the special identification fields; if a mail contains the special identification field, the special identification field of the mail is filtered. Herein, the mode of filtering the special identification field of the mail may include deleting the special identification field of the mail or adding new content in the special identification field of the mail.

In the example of the present invention, system mails can be sent to the target user without needing to be sent through any Mail Transfer Agent of the E-mailbox system, but all normal mails except the system mails can not be sent to the target user unless the normal mails are sent through the Mail Transfer Agents of the E-mailbox system. When all mails received by the all Mail Transfer Agents of the E-mailbox system are scanned and the special identification fields of the mails are filtered, all mails except the system mails need to be filtered, so that the filtered normal mails does not contain the special identification fields, but all the system mails contain the special identification fields.

In step S103, it is determined whether the mails are system mails through checking whether the mails contain the special identification fields; if it is determined that a mail is a system mail, the system mail is outputted in a mode different from a mode of outputting a normal mail.

In the example of the present invention, since the mails received by all Mail Transfer Agents of the E-mailbox system are scanned and the special identification fields contained in the mails are filtered, the mails received by the Mail Transfer Agents do not certainly contain the special identification fields, but the system mails contain the special identification fields and do not need to be sent through the Mail Transfer Agents, and thus it can be determined whether a mail is a system mail or a normal mail through checking whether the received mails contain the special identification fields. If a mail is a system mail, the system mail is outputted in a mode different from a mode of outputting a normal mail.

In the example of the present invention, the topic of the system mail may be displayed with a color different from the color of the topic of a normal mail, e.g., when the topic of the normal mail is displayed with black, the topic of the system mail may be displayed with a color except black. The system mail may also be displayed after an icon is added, or the icon of the system mail is displayed in a mode different from the mode of displaying the icon of the normal mail, e.g., when the icon of the normal mail is defaulted, the icon of the system mail is displayed in any mode. The system mail may also be displayed in a font different from the font of the normal mail, e.g., when the normal mail is displayed in Song typeface, the system mail is displayed in any font except Song typeface. It can be easily understood that, the mode of outputting the system mail should not be limited to the above several modes, and according to the user requirements, the system mail may be outputted in other modes different from the mode of outputting the normal mail.

In another example of the present invention, in order to prevent users from being influenced by vicious mails, when a normal mail is outputted, codes which can be executed at client are prohibited, but when the system mail is outputted, the codes are not prohibited, so that the system mail may be displayed in richer modes.

In order to facilitate users to differentiate system mails from normal mails, in another example of the present invention, the method further includes the following steps.

When it is detected that a mouse pointer hovers over the outputted system mail, the user is prompted that the mail is the system mail. The mode of prompting the user that the mail is the system mail includes outputting a prompt box, adding a displaying column and so on.

Since it takes much time to check whether the mails contain the special identification fields, the performance of the E-mailbox system will be decreased. In order to improve the performance of the E-mailbox system, in another example of the present invention, the method further includes the following steps.

A value of the special identification field is configured in a mail index, it is determined whether the mail is the system mail through checking the value of the special identification field in the mail index, and when it is determined that the mail is the system mail, the system mail is outputted in a mode different from the mode of outputting the normal mail.

In the example of the present invention, the mail server caches mails from all Mail Transfer Agents of the E-mailbox system in the serving area of the mail server, and then stores the mails in folders of target users. If a mail contains the special identification field, the mail server stores a value corresponding to the special identification field in the special identification field of the mail index; if the mail does not contain the special identification field, the special identification field of the mail index is configured as a default value, so as to determine whether the mail is a system mail through checking the value of the special identification field in the mail index.

When a system mail is sent, in order to identify the type of the system mail, a value for identifying the type of the system mail is configured for the special identification field of the system mail. In another example of the present invention, the method further includes the following steps.

It is determined whether a mail is a system mail through checking whether the mail contains the special identification field; if the mail is a system mail, the type of the system mail may be obtained through checking the value of the special identification field of the system mail. The system mail is outputted in a mode different from the mode of outputting the normal mail, and further different types of system mails are outputted in different modes.

Since some mails, e.g., system mails, are aging for a user, i.e., it is meaningless to continue storing the mails after an aging time or the user reads the mails, the mails will become junk mails in the mailbox of the user after the aging time, which not only occupy precious mail server resources, but also cause difficulty for the user to manage the mailbox. In order to facilitate to manage the mailbox, decrease the difficulty of managing the mailbox and save the mail server resources, in another example of the present invention, when the special identification field is configured for the system mail, a value for identifying the type of the system mail as a self-delete mail type is configured (in order to be convenient for description, called as self-delete type). When the value of the special identification field of the system mail indicates the self-delete type, the method further includes the following steps.

In step S104, a self-delete field is configured for the system mail, and the self-delete field is used for identifying whether to perform self-delete processing for the system mail. In another example of the present invention, the self-delete field is also used for identifying self-delete time.

In the example of the present invention, when self-delete fields are configured for system mails, values of the self-delete fields of all system mails are configured uniformly, and the self-delete time of the system mails is configured uniformly; or a configuration interface of the self-delete fields is provided to the user, so that the user self-defines the values of the self-delete fields of the system mails; or when the self-delete fields needs to be configured for the system mails, values of the self-delete fields in one part of the system mails and the self-delete time of these system mails are configured uniformly, and the values of self-delete fields in the other one part of the system mails are configured by the user.

In step S105, it is checked in real time whether a self-delete mail expires, and the self-delete mail is deleted when it is detected that the self-delete mail expires.

It is determined whether a self-delete mail expires through checking the value of the self-delete field of the self-delete mail, but it takes much time to directly check the value of the self-delete field of the self-delete mail, and thus the performance of the E-mailbox system may be decreased. In order to improve the performance of the E-mailbox system, in another example of the present invention, the method further includes the following steps.

A self-delete field is added into the mail index, it is determined whether an expired self-delete mail is detected through real-time checking the self-delete field in the mail index, and the self-delete mail is deleted when the expired self-delete mail is detected.

In order to make the user differentiate the self-delete mail from normal mails, so as to view mail contents before the self-delete mail is deleted, in another example of the present invention, the method further includes the following steps after step S104.

The self-delete mail is outputted in a mode different from the mode of outputting the normal mail or in a mode different from the mode of outputting the normal mail and the system mail.

In order to facilitate the user to differentiate the self-delete mail from other mails, in another example of the present invention, the method further includes the following steps.

When it is determined that the mouse pointer hovers over the outputted self-delete mail, the user is prompted that the mail is the self-delete mail. The mode of prompting the user that the mail is the self-delete mail includes outputting a prompt box, adding a displaying column and so on. When the user is prompted that the mail is the self-delete mail, the self-delete time of the mail is also prompted. The method of cancelling the self-delete configuration may also be prompted.

In order to make the user self-define the value of the self-delete field of the mail, so as to manage the mail more conveniently, in another example of the present invention, the method further includes the following steps:

receiving a configuration instruction of the self-delete field and the value of the self-delete field which are inputted by the user and updating the value of the self-delete field of the mail into the value of the self-delete field inputted by the user.

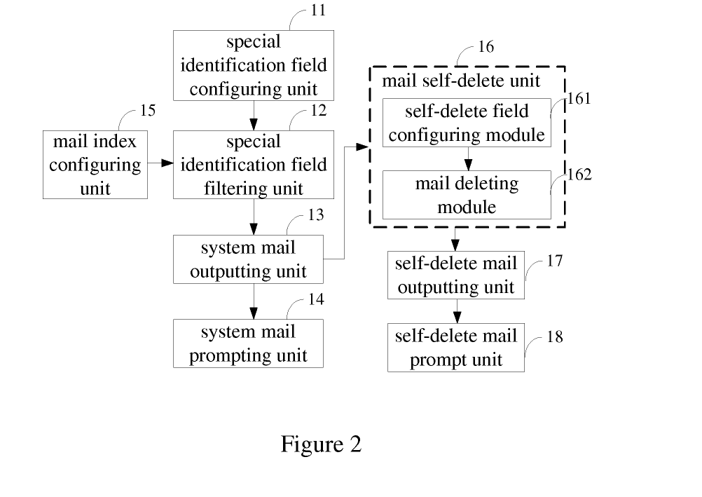

FIG. 2 is a schematic diagram illustrating the structure of an apparatus for outputting a system mail according to an example of the present invention. In order to be convenient for description, only parts related to the example of the present invention are illustrated. The apparatus for outputting a system mail may be a software unit, a hardware unit or a combining unit of software and hardware configured in an E-mail system, or may be an independent pendant integrated in the E-mail system or in an application system of the E-mail system.

A special identification field configuring unit 11 configures a special identification field for a system mail. The special identification field is a special field of the system mail, and is used for identifying that a mail is the system mail. In the example of the present invention, the special identification field is added into the head information of the mail, or added into other parts of the mail, e.g., a mail body.

Since there may be multiple types of system mails, in order to identify the types of system mails, in another example of the present invention, multiple different values are configured for the special identification fields of the system mails, and each value indicates one type of system mail. The special identification field configuring unit 11 also configures different values for the special identification fields of the system mails, so as to identify the types of the system mails.

A special identification field filtering unit 12 scans mails received by all Mail Transfer Agents of an E-mailbox system, and filters the special identification fields contained in the mails received by the Mail Transfer Agents. The Mail Transfer Agents of the E-mailbox system include Web Mail User Agents, SMTP Agents, MX Agents and so on. Herein, the mode of filtering the special identification fields of the mails may include deleting the special identification fields of the mails or adding new content in the special identification fields of the mails.

A system mail outputting unit 13 determines whether the mails are system mails through checking whether the received mails contain the special identification fields; when determining that a mail is the system mail, outputs the system mail in a mode different from a mode of outputting a normal mail.

In the example of the present invention, the topic of the system mail may be displayed with a color different from the color of topic of a normal mail, e.g., when the topic of the normal mail is displayed with black, the topic of the system mail may be displayed with a color except black. The icon of the system mail is displayed in a mode different from the mode of displaying the icon of the normal mail, e.g., when the icon of the normal mail is defaulted, the icon of the system mail is displayed in any mode. The system mail may also be displayed in a font different from the font of the normal mail, e.g., when the normal mail is displayed in Song typeface, the system mail is displayed in any font except Song typeface. It can be easily understood that, the mode of the outputting the system mail should not be limited to the above several modes, and according to the user requirements, the system mail may be outputted in other modes different from the mode of outputting the normal mail.

In order to facilitate users to differentiate system mails from normal mails, in another example of the present invention, the apparatus includes a system mail prompt unit 14. The system mail prompt unit 14 prompts the user that the mail is the system mail when detecting that a mouse pointer hovers over the outputted system mail. The mode of prompting the user that the mail is the system mail includes outputting a prompt box, adding a displaying column and so on.

Since it takes much time to check whether the mails contain the special identification fields, the performance of the E-mailbox system will be decreased. In order to improve the performance of the E-mailbox system, in another example of the present invention, the apparatus further includes a mail index configuring unit 15. The mail index configuring unit 15 configures the special identification field in a mail index, stores the value of the special identification field contained in the mail in the special identification field of the mail index; when the mail does not contain the special identification field, configures the special identification field of the mail index as a default value. At this time, the special identification field filtering unit 12 determines whether the mail is a system mail through checking the value of the special identification field in the mail index, and when determining that the mail is the system mail, outputs the system mail in a mode different from the mode of outputting the normal mail.

When a system mail is sent, in order to identify the type of the system mail, a value for identifying the type of the system mail is configured for the special identification field of the system mail. In another example of the present invention, the system mail outputting unit 13 determines whether a mail is a system mail through checking whether the mail contains the special identification field; if the mail is a system mail, obtains the type of the system mail through checking the value of the special identification field of the system mail, and output the system mail in a mode different from the mode of outputting the normal mail, and further outputs different types of system mails in different modes.

Since some mails, e.g., system mails, are aging for a user, i.e., it is meaningless to continue storing the mails after an aging time or the user reads the mails, the mails will become junk mails in the mailbox of the user after the aging time, which not only occupy precious mail server resources, but also cause difficulty for the user to manage the mailbox. In order to facilitate to manage the mailbox, decrease the difficulty of managing the mailbox and save the mail server resources, in another example of the present invention, the apparatus further includes a mail self-delete unit 16. The mail self-delete unit 16 performs self-delete processing for the mail according to the value of the self-delete field of the mail, and includes a self-delete field configuring module 161 and a mail deleting module 162.

The self-delete field configuring module 161 configures a self-delete field for the system mail, and the self-delete field is used for identifying whether to perform self-delete processing for the system mail. In another example of the present invention, the self-delete field is also used for identifying self-delete time.

In the example of the present invention, when self-delete fields are configured for system mails, values of the self-delete fields of all system mails are configured uniformly, and the self-delete time of the system mails is configured uniformly; or a configuration interface of the self-delete fields is provided to the user, so that the user self-defines the values of the self-delete fields of the system mails; or when the self-delete fields need to be configured for the system mails, values of the self-delete fields in one part of the system mails and the self-delete time of these system mails are configured uniformly, and the values of self-delete fields in the other one part of the system mails are configured by the user. In order that the user self-defines the values of the self-delete fields of the system mails, so as to manage the system mails more conveniently, in another example of the present invention, the self-delete field configuring module 161 is configured to receive a configuration instruction of the self-delete field and the value of the self-delete field which are inputted by the user, and updates the value of the self-delete field of the mail into the value of the self-delete field inputted by the user.

The mail deleting module 162 checks in real time whether a self-delete mail expires, and deletes the self-delete mail when detecting that the self-delete mail expires.

It is determined whether a self-delete mail expires through checking the value of the self-delete field of the self-delete mail, but it takes much time to directly check the value of the self-delete field of the self-delete mail, and thus the performance of the E-mailbox system is decreased. In order to improve the performance of the E-mailbox system, in another example of the present invention, the mail index configuring unit 15 is further configured to add a self-delete field into the mail index, and stores the value of the self-delete field of the mail in the self-delete field of the mail index. At this time, the mail deleting module 162 determines whether an expired self-delete mail is detected through real-time checking the self-delete field of the mail in the mail index, and when detecting the expired self-delete mail, deletes the expired self-delete mail.

In order to make the user differentiate the self-delete mail from normal mails, so as to view mail contents before the self-delete mail is deleted, in another example of the present invention, the apparatus further includes a self-delete mail outputting unit 17. The self-delete mail outputting unit 17 outputs the self-delete mail in a mode different from the mode of outputting the normal mail or in a mode different from the mode of outputting the normal mail and the system mail.

In order to facilitate the user to differentiate the self-delete mail from other mails, in another example of the present invention, the apparatus further includes a self-delete mail prompt unit 18. The self-delete mail prompt unit 18 prompts the user that the mail is the self-delete mail when determining that the mouse pointer hovers over the outputted self-delete mail. The mode of prompting the user that the mail is the self-delete mail includes outputting a prompt box, adding a displaying column and so on. When the user is prompted that the mail is the self-delete mail, the self-delete time of the mail is also prompted. The mode of canceling the self-delete configuration may also be prompted.

In the examples of the present invention, a special identification field is configured for the system mail, the mails received by all Mail Transfer Agents of the E-mailbox system are scanned, and the special identification fields contained in the mails received by the Mail Transfer Agents are filtered; it is determined whether the mails are system mails by determining whether the mails contain the special identification fields, so as to prevent the system mail being faked; when determining a mail is a system mail, the system mail is outputted in a mode different from a mode of outputting a normal mail, so as to facilitate the user differentiate system mails from normal mails. Through configuring the values of the special identification fields of the system mails, performing classification management for the system mails, and outputting different types of system mails in different modes, the user may perform classification management for the system mails conveniently. Through configuring the self-delete field, and further performing self-delete processing for the mail according to the self-delete field of the mail, the management of user mailbox is simplified. Using the mail index to index the value of the special identification field, it can be determined whether the mail is the system mail, so as to improve the performance of the E-mailbox system.

The foregoing is only the preferred examples of the present invention and is not used to limit the protection scope of the present invention. Any modification, equivalent substitution and improvement without departing from the principle of the present invention are within the protection scope of the present invention.

1. A method for outputting a system mail, comprising:
configuring, a special identification field for a system mail;
scanning mails received by all Mail Transfer Agents of an E-mailbox system, and filtering special identification fields contained in the mails;
determining whether the mails are system mails through checking whether the mails received by the E-mailbox system contain the special identification fields; when determining that a mail is a system mail, outputting the system mail in a mode different from a mode of outputting a normal mail.

2. The method of claim 1, wherein filtering special identification fields contained in the mails comprises one of:
deleting the special identification fields contained in the mails, and
adding new content into the special identification fields contained in the mails.

3. The method of claim 1, after outputting the system mail in the mode different from the mode of outputting the normal mail, further comprising:
prompting that the system mail is a system mail when detecting that a mouse pointer hovers over the system mail.

4. The method of claim 1, wherein configuring a special identification field for a system mail comprising: configuring a value for the special identification field, wherein the value is used for identifying the type of the system mail.

5. The method of claim 4, wherein outputting the system mail in a mode different from a mode of outputting a normal mail comprises: outputting different types of system mails in different modes.

6. The method of claim 4, wherein the value for identifying the type of the system mail comprises a value of a self-delete mail type, and the value of the self-delete mail type comprises self-delete time, and is used for identifying whether to perform self-delete processing for the mail;
after outputting the system mail in the mode different from the mode of outputting the normal mail, the method further comprises: configuring a self-delete field for the system mail, checking in real time whether there is an expired self-delete mail, and when detecting the expired self-delete mail, deleting the self-delete mail.

7. The method of claim 6, wherein checking in real time whether there is an expired self-delete mail, and when detecting the expired self-delete mail, deleting the self-delete mail comprising:
adding a self-delete field in a mail index, and storing a value of the self-delete field of the system mail in the self-delete field of the mail index;
determining, through checking the self-delete field of the mail index, whether an expired self-delete mail is detected, and when detecting the expired self-delete mail, deleting the self-delete mail.

8. The method of claim 6, after configuring the self-delete field for the system mail, further comprising:
outputting the self-delete mail in a mode different from the mode of outputting the normal mail, or outputting the self-delete mail in a mode different from the mode of outputting the normal mail and the system mail.

9. An apparatus for outputting a system mail, comprising:
a special identification field configuring unit, configured to configure a special identification field for a system mail;
a special identification field filtering unit, configured to scan mails received by all Mail Transfer Agents of an E-mailbox system, and filter special identification fields contained in the mails;
a system mail outputting unit, configured to determine whether a mail is a system mail through checking whether the mails received by the E-mailbox system contain the special identification fields; when determining that the mail is a system mail, output the system mail in a mode different from a mode of outputting a normal mail.

10. The apparatus of claim 9, further comprising:
a system mail prompting unit, configured to prompt that the system mail is the system mail when detecting that a mouse pointer hovers over the system mail.

11. The apparatus of claim 9, further comprising:
a mail self-delete unit, configured to perform, according to a predefined value of a self-delete field of the mail, self-delete processing for a system mail with the value of the self-delete field.

12. The apparatus of claim 11, wherein the mail self-delete unit comprises:
a self-delete field configuring module, configured to configure the mail self-delete field for the system mail, wherein the system mail is a self-delete mail, and the self-delete field is used for identifying whether to perform self-delete processing for the self-delete mail, and further used for identifying self-delete time;
a mail deleting module, configured to check in real time whether there is an expired self-delete mail, and when detecting that there is an expired self-delete mail, delete the self-delete mail.

13. An E-mailbox system, comprising the apparatus for outputting a system mail claimed by claim 9.
